(19) United States
(12) Patent Application Publication
(10) Pub. No.: US 2007/0188283 A1
(43) Pub. Date: Aug. 16, 2007

(54) Ignition coil for a gasoline engine and method for its manufacture

(76) Inventors: Markus Weimert, Immenstadt (DE); Tim Skowronek, Missen-Wihams (DE)

Correspondence Address: KENYON & KENYON LLP, ONE BROADWAY, NEW YORK, NY, 10004, US

(21) Appl. No.: 10/573,607

(22) PCT Filed: Sep. 15, 2004
(86) PCT No.: PCT/EP04/52180

§ 371 Date: Apr. 11, 2007

(30) Foreign Application Priority Data
Sep. 26, 2003 (DE) 103 44 892.6

(51) Int. Cl. H01F 27/02

(52) U.S. Cl. 336/90

(57) ABSTRACT

Described is an ignition coil for a gasoline engine including a coil core on which at least one winding layer of a primary winding is wound up, on which in turn at least one winding layer of a secondary winding is wound up. At least one winding layer of shield winding is situated between the at least one winding layer of the primary winding and the at least one winding layer of the secondary winding. Furthermore, a method for manufacturing such an ignition coil is described.

### FIELD OF THE INVENTION

The present invention relates to an ignition coil for a gasoline engine including a coil core on which at least one winding layer of a primary winding is wound up. At least one winding layer of a secondary winding is wound onto the at least one winding layer of the primary winding.

### BACKGROUND INFORMATION

Moreover, the present invention relates to an ignition coil for a gasoline engine including a coil core on which at least one winding layer of a secondary winding is wound up. At least one winding layer of a primary winding is wound onto the at least one winding layer of the secondary winding.

Finally, the present invention relates to a method for manufacturing an ignition coil for a gasoline engine.

Such an ignition coil represents a power-transmitting high voltage source and is used in a gasoline engine for activating the spark plug, which in turn ignites the fuel mixture in the engine's combustion chamber, thereby initiating the movement of the piston and thus the crank shaft.

In principle, an ignition coil is made up of two windings having differing numbers of turns which—supported by an iron core or a similar coil core—are magnetically coupled with one another. The winding having the smaller number of turns is referred to as the primary winding and the one having the greater number of turns is referred to as the secondary winding. The primary winding is used as an excitation winding, receives its power from the car battery, and is activated by the engine management via an electronic switch.

A high voltage is generated in the secondary winding due to a selective interruption in the primary circuit, the high voltage being relayed to the spark plug, resulting there in a spark.

As a rule, the primary winding and the secondary winding are situated concentrically on top of each other. One end of the secondary winding may lead to the high voltage terminal of the spark plug while the other end is connected to the ground potential.

From practice it is also known that both ends of the secondary winding each lead to a high voltage output, i.e., one ignition coil operates two spark plugs simultaneously. This is known as a two-spark coil or also dual-spark coil.

Due to the spark formation between its electrodes, the spark plug represents an interference source in terms of EMC (electromagnetic compatibility) and may thus negatively influence other components in the system formed by the vehicle electrical network. These interferences may spread in a line-bound manner as well as in a radiating manner, mostly the line-bound portion being more important today. Electrical interference signals, caused by the spark formation, may travel from the spark plug via the ignition coil into the vehicle electrical network, for example. These signals couple from the secondary circuit of the ignition coil into the primary circuit, inductively as well as capacitively, thereby reaching the vehicle electrical network. Parasitic capacitances are formed between the primary winding and the secondary winding.

It is possible in one-spark coils to “discharge” the interferences to the ground potential via a very good, i.e., a low-impedance ground connection of the low voltage side of the secondary winding, thereby disposing of the interferences. In addition, interference suppression may be achieved by interference-suppression resistors, interference-suppression inductances, and interference-suppression capacitances.

However, the possibility of the secondary ground connection is omitted in two-spark coils and only the interference-suppression resistors and/or interference-suppression inductances and/or interference-suppression capacitances remain as interference suppression possibilities.

A further means for interference suppression is an electrical shield between the primary winding and the secondary winding such as is known from network transformers, for example. In this instance, the shield is obtained using an electrically conducting foil which, however, may disadvantageously only be inserted between the two windings at a great production expense.

Furthermore, the electrical connection of the foil to ground presents a problem.

### SUMMARY OF THE INVENTION

The present invention is based on the object of providing an ignition coil for a gasoline engine and a method for its manufacture which, compared to known ignition coils, ensure(s) improved shielding essentially without additional interference suppression components, also when operated as a two-spark coil.

In addition, the ignition coil according to the present invention should be able to be easily manufactured from the technical point of view and the manufacturing method according to the present invention should be able to be easily executed.

In the ignition coil according to the present invention, at least one winding layer of a shield winding is situated between the at least one winding layer of the primary winding and the at least one winding layer of the secondary winding. The shield winding ensures efficient interference suppression and reduces the use of the necessary interference suppression components known from practice.

Moreover, the application of a shield winding is less expensive than the known insertion of a shielding foil between the primary and secondary windings.

A particularly efficient integration of the shield winding into the manufacturing process of the primary winding is achieved if the primary winding has at least two winding layers, the top winding layer of the primary winding, facing the secondary winding, forming a winding layer of the shield winding.

Such an ignition coil for a gasoline engine may be manufactured in a simple manner by winding in a first step a first winding layer, e.g., of the primary winding, of an electrically conductive, insulated wire onto a coil core in a first winding direction. In a second step, at least one further winding layer, e.g., of the primary winding, of the wire is wound up on the first winding layer in a second winding direction which is opposite to the first winding direction. The wire is cut through at the start of the top winding layer. This creates two free wire ends of the top winding layer which in turn forms a winding layer of a shield winding. Subsequently, a coil winding, e.g., of the secondary winding, detached and separate from the existing winding layers, e.g., of the primary winding, is wound up with at least one winding layer.

Alternatively to this configuration, the secondary winding may also have at least two winding layers, the bottom winding layer of the secondary winding, facing the primary winding, forming a winding layer of the shield winding.

Also in the case of an ignition coil, in which at least one winding layer of a secondary winding is wound up on the coil core and onto which in turn at least one winding layer of a primary winding is wound, at least one winding layer of a shield winding may be situated between the at least one winding layer of the secondary winding and the at least one winding layer of the primary winding.

An efficient integration of the shield winding into the manufacturing process of the primary winding is achievable for this configuration if the primary winding has at least two winding layers, the bottom winding layer of the primary winding, facing the secondary winding, forming a winding layer of the shield winding.

Such an ignition coil may be manufactured in a simple manner by winding a first winding layer of an electrically conducting, insulated wire, e.g., of the primary winding, in a first winding direction onto a separate coil winding, e.g., of the secondary winding, with at least one winding layer. At least one further winding layer of the wire, e.g., of the primary winding, is wound up on the first winding layer in a second winding direction which is opposite to the first winding direction. For forming two free wire ends of the first winding layer, the wire is cut through at the start of the first winding layer, e.g., of the primary winding. This creates a separate shield winding between the secondary and primary windings.

The secondary winding may alternatively have at least two winding layers, the top winding layer of the secondary winding, facing the primary winding, forming a winding layer of the shield winding.

For reliable interference suppression, the shield winding is connected to the ground potential on least at one free end. The other free end may be attached to the ignition coil in an electrically insulated manner.

It is particularly advantageous for the manufacturing process that, during a change in the winding direction, the wire may be secured in a holding device when transitioning to a further winding layer. This facilitates handling and subsequent contacting, in particular when the wire is cut through and the shield layer is formed. One of the two free wire ends of the shield winding may be secured in the holding device and connected to the ground potential in a simple manner.

The holding device may be situated on both ends of the coil core so that the wound up wire of the primary winding as well as the secondary winding may be secured there.

The holding device may advantageously include an IPCD (insulation piercing connecting device) which facilitates contacting.

It should be explicitly pointed out at this point that the terms “primary winding” and “secondary winding” may basically be interchanged during the manufacture of an ignition coil because the “primary winding” and “secondary winding” functions are only assigned to the windings when the ignition coil is connected to the ignition circuit. Although primary and secondary windings often differ from one another with respect to their number of turns, the number of turns is always variable in the manufacture of an ignition coil and is, among other things, also dependent on the wire thickness.

A more efficient integration of the shield into the ignition coil is achieved by the ignition coil according to the present invention and its manufacturing method. In this way, ignition coils, two-spark or dual-spark coils in particular, have an effective possibility of interference suppression which may not require additional interference suppression elements and which may be readily integrated into the ignition coil's normal manufacturing process.

### BRIEF DESCRIPTION OF THE DRAWINGS

FIG. 1 shows a schematic diagram which clarifies the principal configuration of an ignition system including a two-spark coil and interference suppression components.

FIG. 2 shows a schematic side view and a half section of the configuration of a layer winding of a primary winding.

FIG. 3 shows a schematic side view and a half section of the configuration of a shield winding.

### DETAILED DESCRIPTION

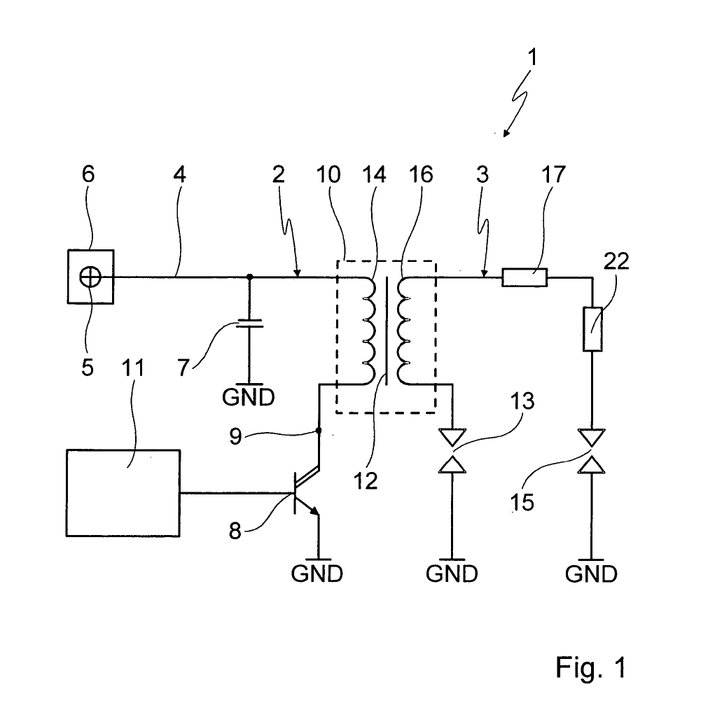

FIG. 1 shows a schematic diagram which clarifies the principal configuration of an ignition system 1 including an ignition coil 10 according to the present invention.

Ignition system 1 is composed of a control circuit 2, which is referred to as the primary circuit, and an ignition circuit 3 which forms a secondary circuit. Primary circuit 2 and secondary circuit 3 are coupled to one another via ignition coil 10, which is designed as a two-spark coil, primary circuit 2 including a power supply line 4 which connects a terminal 5 of a battery 6 of the motor vehicle to the end of a primary winding 14 of ignition coil 10.

Between battery 6 or its terminal 5 and primary winding 14 of ignition coil 10, an interference suppression capacitor 7 at power supply line 4 is switched against ground GND. If an appropriately shielded ignition coil is used, interference suppression capacitor 7 may be omitted in an alternative embodiment.

In addition, primary circuit 2 includes a transistor 8 which is wired up to the second end of primary winding 14 via a terminal 9 and which is controlled at the base via an engine management 11 of a drive engine of the motor vehicle.

Primary winding 14 is wound up on a coaxial coil core 12 which may be made of iron, for example. A secondary winding 16 of ignition coil 10 is wound on top of it, the secondary winding being part of secondary circuit 3 and one end of the secondary winding being in contact in a known manner with a first spark plug 13 which is situated in secondary circuit 3 between secondary winding 16 and ground GND. The second end of secondary winding 16 is connected to a second spark plug 15 of a drive engine representing a gasoline engine, an interference suppression resistor 17 and preferably an interference suppression inductance 22 being situated in secondary circuit 3 between secondary winding 16 and second spark plug 15, and second spark plug 15 as well as first spark plug 13 are wired up to a contact terminal having a ground potential GND.

In a design variant, interference suppression resistor 17 and/or interference suppression inductance 22 may possibly be omitted when a correspondingly heavily shielded ignition coil is used.

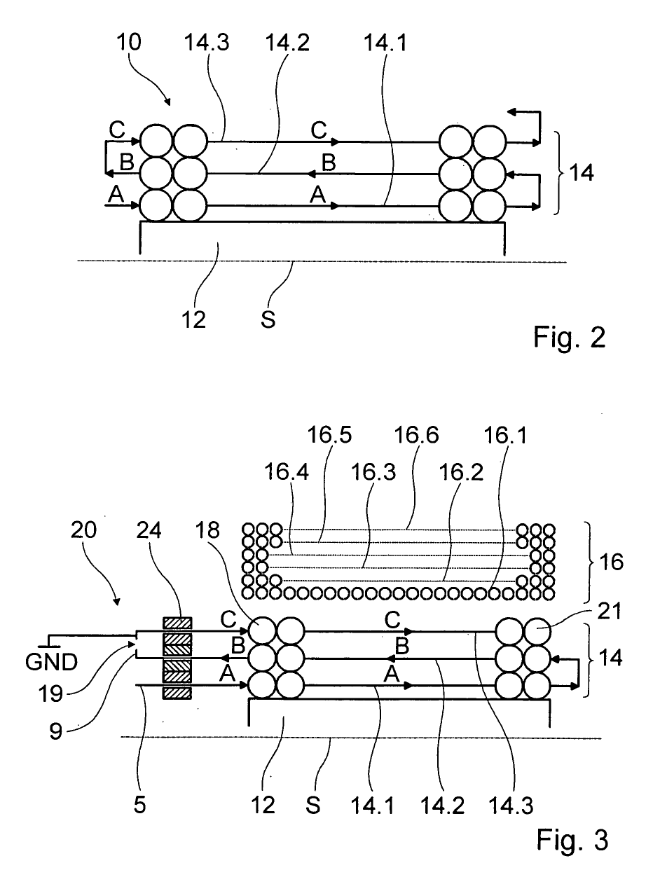

FIG. 2 shows a schematic side view and a half section of the first steps for configuring a layer winding of primary winding 14 of ignition coil 10 which is essentially configured concentrically symmetrically to a symmetry line S shown in FIG. 2.

In the layer winding, an electrically conducting wire is initially wound up on a winding core which forms coil core 12. A first winding layer 14.1 is formed in that the wire is wound in a first winding direction A from a left end of winding core 12 to a right end of same as shown in FIG. 2.

Starting from the right end of winding core 12, as shown in FIG. 2, the wire is wound back to the left end in a second winding layer 14.2, which is situated on top of first winding layer 14.1, in an opposite second winding direction B.

Starting from the left end of winding core 12, as shown in FIG. 2, the wire is subsequently wound to the right end of winding core 12 in a third winding layer 14.3, which is situated on top of second winding layer 14.2, in a winding direction C corresponding to the first winding direction. In principle, any number of layers may be built up to form a layer winding.

FIG. 3 shows a schematic side view and a section of the configuration of a shield winding 18 of ignition coil 10, three winding layers 14.1, 14.2, and 14.3 of primary winding 14 being applied to coil core 12 of ignition coil 10, as explained above on the basis of FIG. 2.

Shield winding 18 is to be placed between primary winding 14 and secondary winding 16 of ignition coil 10, secondary winding 16 being wound up on top of primary winding 14 in six winding layers 16.1 through 16.6 in the present exemplary embodiment. For forming shield winding 18, top layer 14.3 of primary winding 14 is used as the layer of shield winding 18. For this purpose, top winding layer 14.3 of primary winding 14 is electrically severed via a cut from its bottom layers 14.2 and 14.1, which form the actual primary winding 14, at a separation point 19 shown in FIG. 3. This creates two free ends 20 and 21 of winding layer 14.3, now representing a shield layer, a first free end 20 of shield layer 14.3 being connected to ground potential GND.

According to FIG. 1, the free end of second winding layer 14.2 of primary winding 14, also created by separation point 19, is connected to terminal 9 which establishes the connection to transistor 8. According to FIG. 1, the free end, i.e., the start of the wire of first winding 14.1. of primary winding 14 is connected to battery 6 of the motor vehicle via terminal 5.

This configuration enables continuous manufacturing of primary winding 14 and shield winding 18. During the layer change, the wire is held in a holding device 24, which includes insulation piercing contact receptacles. Cutting of the wire at separation point 19 of top winding 14.3 and contacting take place after the winding process is complete.

While first free wire end 20 of shield winding 18, created at separation point 19, is connected to ground GND, other wire end 21 of shield winding 18 is secured to ignition coil 10 in an insulated manner. As a rule, a one-sided ground connection of shield winding 18 is sufficient for effective shielding.

As an alternative, an additional top winding layer, which is used as the shield winding, may be applied on the primary winding.

It is irrelevant whether the actual primary winding has an even or uneven number of winding layers. In the event of an uneven number of layers, the wire is initially guided along the coil core from one end straight to the other end at which the actual winding starts, now again in the direction of the start of the wire. Here the wire is wound over the wire section which was guided to the back.

A shield winding according to the above-described manufacturing method may also be implemented when the primary winding is situated externally or concentrically on top of the secondary winding. The wire, initially guided straight to the back, forms the shield winding together with the first winding layer of the primary winding. The wire is cut after the first layer is wound up, so that the other winding layers applied on top again form the actual primary winding.

In principle, the manufacturing method according to the present invention provides the possibility of implementing an additional winding in the ignition coil. The described embodiments of an additional winding do not inevitably relate to only one shield winding. Similarly, other auxiliary windings may be created based on the same principle, such as a winding for premagnetization of the ignition coil.

1.-13. (canceled)

14. An ignition coil for a gasoline engine, comprising:
at least one first winding layer of a primary winding;
a coil core on which the at least one first winding layer is wound up;
at least one second winding layer of a secondary winding that is wound up on the at least one first winding layer; and
at least one third winding layer of a shield winding, the at least one third winding layer being situated between the at least one first winding layer and the at least one second winding layer.

15. The ignition coil as recited in claim 14, wherein the primary winding includes at least two winding layers, the top winding layer of the primary winding, facing the secondary winding, forming a winding layer of the shield winding.

16. The ignition coil as recited in claim 15, wherein the secondary winding has at least two winding layers, the bottom winding layer of the secondary winding, facing the primary winding, forming a winding layer of the shield winding.

17. An ignition coil for a gasoline engine, comprising:
at least one winding layer of a secondary winding;
a coil core on which the at least one winding layer of the secondary winding is wound up;
at least one winding layer of a primary winding that is wound up on the at least one winding layer of the secondary winding; and
at least one winding layer of a shield winding being situated between the at least one winding layer of the secondary winding and the at least one winding layer of the primary winding.

18. The ignition coil as recited in claim 17, wherein the primary winding has at least two winding layers, the bottom winding layer of the primary winding, facing the secondary winding, forming a winding layer of the shield winding.

19. The ignition coil as recited in claim 17, wherein the secondary winding has at least two winding layers, the top winding layer of the secondary winding, facing the primary winding, forming a winding layer of the shield winding.

20. The ignition coil as recited in claim 17, wherein the shield winding is connected to a ground potential.

21. A method for manufacturing an ignition coil for a gasoline engine, comprising:
winding up a first winding layer of an electrically conducting, insulated wire on a coil core in a first winding direction;
winding up at least one additional winding layer of the wire on the winding layer underneath it in a winding direction opposite the winding direction of the winding layer underneath it;
separating the wire at the start of the top winding layer for forming two free wire ends of the top winding layer; and
winding up a separate coil winding, separated from the existing winding layers with at least one winding layer.

22. A method for manufacturing an ignition coil for a gasoline engine, comprising:
winding up a first winding layer of an electrically conducting, insulated wire in a first winding direction on a separate coil winding with at least one winding layer;
winding up at least one additional winding layer of the wire on the first winding layer in a second winding direction opposite the first winding direction; and
separating the wire at the start of the first winding layer for forming two free wire ends of the first winding layer.

23. The method as recited in claim 22, wherein one wire end of the two free wire ends is connected to ground potential.

24. The method as recited in claim 22, wherein, upon a change of the winding direction, the wire is secured in a holding device during transition to a further winding layer.

25. The method as recited in claim 24, wherein the holding device includes an insulation piercing connecting device.

26. The method as recited in claim 24, wherein one of the two free wire ends is fixed in the holding device and connected to the ground potential.
